(19) United States
(12) Patent Application Publication
(10) Pub. No.: US 2005/0226987 A1
(43) Pub. Date: Oct. 13, 2005

(54) Ready to eat food formulation containing yogurt and pureed cooked vegetables and process for manufacture thereof

(76) Inventor: Marina Shereshevsky, Rockaway, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 10/820,488

(22) Filed: Apr. 8, 2004

(51) Int. Cl. A23L 1/28

(52) U.S. Cl. 426/583

(57) ABSTRACT

A ready to eat vegetable yogurt with homogenous uniform texture is provided at refrigeration temperatures with the taste of freshly cooked pureed vegetables in a yogurt with active cultures and taste and flavor enhancers. The cooked pureed vegetables are optimally cooked and their flavor and freshness are preserved in the product. The cooked pureed vegetable content may be 30-70% by weight providing high nutritional value for the ready to eat vegetable yogurt. The ready to eat vegetable yogurt may be provided with soy based yogurt or milk based yogurt. The manufacturing process for the ready to eat vegetable yogurt cooks the vegetables individually according to their cooking characteristics, cooled and pureed and mixed to the yogurt and blended to form a homogenous uniform mixture of ready to eat vegetable yogurt with smooth texture. It is maintained at all time, until consumed, at refrigeration temperatures to prevent fermentation and preserve freshness and taste of cooked pureed vegetables in the ready to eat vegetable yogurt.

### BACKGROUND OF THE INVENTION

1. Field of the Invention

The present invention relates to a ready to eat food formulation comprising thoroughly mixed pureed cooked vegetables in yogurt and kept at refrigeration temperatures and a process for its manufacture.

2. Description of the Prior Art

Vegetables and fruits have become ubiquitous in the diets of health conscious consumers as a good source of essential vitamins and minerals. Various prior art disclosures addressing food formulations involve ways to conveniently add vegetables to the consumers' diets. In particular, the relevant prior art discloses food products prepared by combining a yogurt with fruits, vegetables, gelatinous compositions, preservatives, artificial flavorings, and sweeteners. Still other prior art references disclose the direct fermentation of vegetables in order to form a vegetable yogurt food product that is derived solely from the enzymatic transformation of the vegetables themselves. However, the prior art does not disclose a homogeneously mixed pureed vegetable yogurt food product that is all natural, highly nutritious, and readily made with a minimum of kitchen utensils.

U.S. Pat. No. 5,143,742 to Maroudas discloses a process for the production of a food product usable as a bread spread, creamy food, and/or a base material for the production of food products consisting predominantly of milk protein, unsaturated vegetable oil and water. The process for the production of the food product employs the dehydration of curds, yogurt, or other milk protein in flocculent form, reducing its weight by 50% to 85%, preferably 50% to 70%. Following dehydration, 4 to 40% by weight unsaturated vegetable oil is added, and the mixture is stirred at room temperature. The process yields a soft, creamy product with a solid consistency similar to that of butter or margarine, and has a neutral taste. The patent further discloses that other additives may be added, including pulverized dried, raw, or cooked vegetables. Significantly, the '742 patent calls for the dehydration of the yogurt, removing water until the weight is reduced from 50 to 85 percent. Following dehydration the '742 patent teaches the addition of unsaturated vegetable oil and, optionally, the addition of pulverized vegetables. The resulting food product consists of an emulsified food product, comprised primarily of dehydrated yogurt and unsaturated vegetable oil (4 to 40% by weight). The properties of this food product are clearly different from a ready to eat vegetable yogurt. Notably, the chemical properties of the yogurt, or other flocculated milk protein, are altered as a result of the dehydration process called for in the '742 patent. Moreover, the addition of unsaturated vegetable oil and pulverized vegetables affect both the consistency and nutritional value of the food product. It is common knowledge that pulverized vegetables lack the nutritional properties of freshly cooked vegetables, and further scientific dicta indicate that unsaturated vegetable oils are not conducive to a healthy diet. The use of oil increases the fat content of the product, resulting in a spreadable formulation, not a ready to eat mixed vegetable yogurt.

U.S. Pat. No. 5,256,438 to Lewis et al. discloses ready-to-eat, preserved fruit products that are dehydrated to a soluble solid level of 40% to 60%, a moisture level of 35% to 55% and a water activity level of 0.75 to 0.90. The key object of the invention is to provide a natural edible fruit product, which will not freeze at 0° C. to −25° C., more particularly −15° C. to −25° C., preferably about −20° C. The '438 patent further discloses processes for producing the preserved fruit products and foods containing the fruit products. Specifically, the '438 patent teaches that the preserved, “non-freeze”, fruit products can be used as additives to yogurts, ice creams, and frozen deserts. It does not disclose the addition of fresh fruits, but rather calls for the addition of dehydrated fruits, which intrinsically contain greater sugar concentrations than their hydrated counterparts. The '438 patent discloses a method for preserving fruit through dehydration and optionally adding the preserved fruit to yogurt, ice cream and the like, but does not set forth a ready to eat vegetable yogurt food product.

U.S. Pat. No. 6,488,973 to Wright discloses a cooking pouch that contains a frozen food product. This frozen food product is comprised of raw protein, raw or partially cooked vegetables, and a sauce. Preferably, the raw protein product consists of fish, beef, or poultry. While the vegetables utilized include julienne peppers, chopped celery, carrots, onions, zucchini or broccoli. The '973 patent teaches that the sauce used can include at least one of the following ingredients: garlic butter, pecan butter, lemon dill, meuniere, etoufee, etoufee with shrimp and/or dijon garlic. Significantly, the patent does not disclose the use of milk protein base (i.e. yogurt) or soy yogurt as the sauce. Furthermore, the frozen food product must be subjected to heat before eating, rather than immediate consumption. To facilitate the cooking process, the vegetables in the pouch are partially cooked, so that the time remaining to complete cooking of the vegetables is approximately the same as the time required to cook the raw protein portion. Moreover, the food product is not homogeneously mixed, but rather remains a heterogeneous mixture with the protein portion and vegetables portions remaining in tact. The '973 patent does not disclose a vegetable yogurt food product comprised of a homogeneous mixture of blended pureed vegetables and plain yogurt ready for immediate consumption, but rather discloses a frozen food pouch comprised of a raw protein and vegetable mixture in an enumerated sauce.

U.S. patent application Publication No. 2001/0024669 to Zuccato discloses a process for the production of a vegetable yogurt and the vegetable yogurt product produced from that process. The process utilizes the fermentation of vegetable products by the action of lactic bacteria. Significantly, the process disclosed in the '669 patent application publication uses a vegetable starting material made up of a plurality of vegetable substances of different vegetable species mixed in different ratios. The mixture is then ground and a dense liquid is extracted from the mixture. More water is added in variable amounts according to the type of vegetables used and is then added thereto suitable ratios of different typologies of fruit and/or green vegetables in order to adjust the sugar concentration and pH values of the vegetable fruit mixture. The sugar concentration and pH values are determined based on a range conducive to the development of lactic bacteria. The mixture is thereafter inoculated with either mesophile microorganisms or mircobich species to aid fermentation and thereby produce the vegetable yogurt. Significantly, the process disclosed by '669 patent application calls for the formation of a vegetable ‘yogurt’ that is derived from the vegetables themselves through fermentation of the vegetables. The '669 patent application publication does not disclose a food product comprised of pureed vegetables homogeneously blended with plain yogurt, but in contrast teaches of a food product comprised of vegetables inoculated to form a yogurt derived solely from the enzymatic transformation of the vegetables themselves.

U.S. patent application Publication No. 2002/0160060 to Kim Chen et al. discloses a food product in the form of a bread spread that contains phytoestrogens. Also disclosed is a method for producing the bread spreads. The '060 patent application's object is to set forth a way to introduce phytoestrogens into one's diet by incorporating the estrogen into a food product, such as a bread spread, and thereby avoiding the necessity of taking the estrogen like compound via pharmaceutical pill form. In summary, phytoestrogens are compounds found in plants, which have certain estrogen-like effects. Preferred sources of lignan type phytoestrogen are found in such foods as flax, cereals, legumes and vegetables. Health conditions for which phytoestrogens have been mentioned include cancer of the breast, prostate, uterus, bowel, hypercholesterolemia, atherosclerosis, colon cancer, antioxidation, benign breast disease, premenstrual syndrome, and symptoms associated with menopause. Phytoestrogens are thought to be beneficial in preventing these diseases. Specifically, the '060 patent application discloses a process for incorporating phytoestrogens in the diet by way of a water-in-oil spread. The phytoestrogen food product process in the published '060 patent application comprises the steps of extracting the phytoestrogens from the food source, preparing a spread by combining a fat phase with an aqueous phase, and adding the phytoestrogens and other additives to the resulting emulsion. The phytoestrogen product comprises a fat (i.e. preferably triglyceride fat derived from vegetable sources), water, gelling agent, additives, and phytoestrogens. The resulting food product consists of an emulsified food product, and is suitable as a bread spread, but is not directly ingested as a typical yogurt would be. Rather, it exhibits a solid, butter-like texture. Moreover, there are no vegetables directly added to the '060 patent application food product, rather the lignan phytoestrogen is merely extracted from the vegetables and added. The vegetables themselves are not added to the emulsion. As a result, the bulk of the nutritional value of the vegetable is not added to the food product.

U.S. patent application Publication No. 2003/0091694 to Remo discloses a process for the production of a vegetable yogurt formed by the fermentation of vegetable products such as green vegetables and fruits under the action of lactic acid bacteria. Firstly, the green vegetables and/or fruit are homogenized; water is added to obtain a creamy liquid product, which is then pasteurized. Afterwards the cultures of lactic acid bacteria are inoculated, whereby the fermentation step is carried out at a temperature depending on the strain of lactic acid bacteria being used until the pH reaches a value of about 3.8 to 4.5. At that point fragrances and/or thickening agents, fruit puree, or fruit in small pieces are added and the product is packaged. Significantly, the process disclosed by the '694 patent application calls for the formation of a vegetable yogurt derived from the vegetables themselves through fermentation of the vegetables. The '694 patent application publication does not disclose a food product comprised of pureed vegetables homogeneously blended with plain yogurt, but in contrast teaches of a food product comprised of fermented vegetables inoculated to form a yogurt derived solely from the vegetables themselves.

European Patent No. EP 0002037 to Stussi discloses a method for filling containers with ‘sundae-style’ yogurt including the steps of placing a transparent lid over the top of a container, and providing an opening in the bottom of the closed, empty container. The container is then inverted and a layer of fruit fraction is added to the container to form a layer of fruit preserves, and the remainder of the container is filled with a bacteriologically inoculated, gum stabilized liquid milk fraction. The container is then sealed and incubated, so that fermentation of the liquid milk fraction produces yogurt, followed by refrigeration. In an optional embodiment the container is in its upright position and the milk fraction is added; after incubation the yogurt is produced and a layer of fruit preserves is then added to the top surface of the yogurt, which has sufficient gel strength to support the fruit layer. The method is suited for allowing a technique, which allows a sundae-style yogurt by inhibiting the intermingling of fruit preserves with the yogurt fraction thus yielding a sundae-style yogurt. Another embodiment sets forth a technique for inhibiting intermingling of fruit preserves with the yogurt fraction by providing a water-insoluble, semi-solid edible barrier of hydrogenated animal fat or hydrogenated vegetable oil at the interface between the fruit preserves and the liquid milk or yogurt fraction. The '037 European patent method is suited for the production of a sundae-style yogurt by preventing the homogenous mixture of the fruit preserve layer with the yogurt fraction. Significantly, the fruit preserves are not homogeneously mixed with the yogurt and no vegetables are added to the yogurt. Moreover, the method in the '037 European patent focuses on the inhibition of mixture of the fruit preserve and the yogurt in order to form a sundae like treat and does not produce a well mixed vegetable yogurt.

European Patent No. EP 0655202 to Giani et al. discloses a yogurt including components having healthy functions. The '202 European patent comprises a food product made from a lean yogurt, sugared by 9.4% saccharose. The process further comprises the steps of adding mash, fruit juices, and natural vegetable extracts to the yogurt. The vegetable extracts are obtained by first extracting the juice from the vegetable raw materials through extraction methods such as evaporation. Secondly, the extracted materials are then subject to thermal processing in order to concentrate the extracted juices. The patent also discloses yogurts that have tonic properties, including a bilberry and ginseng yogurt, a passiflore and chamomile yogurt, and a plum mash and strawberry with rhubarb yogurt. Significantly, the '202 European patent calls for the extraction of juice from raw vegetables, followed by concentration of the extract. Extraction of the juice from a vegetable does not recover nutritional characteristics present in the skin or pulp of the vegetable and provides lesser nutritional benefit as compared with consumption of the vegetable as a whole. Furthermore, the '202 European patent discloses thermally heating the juice extract in order to concentrate the juice extract. Such treatment via thermal processes has the tendency to decompose various heat-unstable nutrients and vitamins in the vegetable's extract. This is yogurt mixed with thermally concentrated fruit and vegetable juice extracts, and not a food product comprised of yogurt (milk or soy) homogeneously mixed with pureed whole vegetables.

Great Britain Patent No. GB 2294625 to Oliver discloses a yogurt comprising rosaceous fruit, preferably one or more of apple, pear, plum and/or damson, and additionally comprising one or more vegetables, herbs, and/or spices. The object of the disclosure is to set forth a vegetable type yogurt including the incorporation of rosaceous fruit to act as preservatives for the yogurt food product. Specifically, the '625 patent comprises a roseaceous fruit, a vegetable, and herbs or spices. The yogurt comprises up to 12% by weight of added sugar. The disclosure sets forth that vegetables are to be added and shall comprise one or more of celery, tomato, beet root, courgette, pepper, marrow, onion, leeks, parsnips, swede, carrots, beans and/or potato. Furthermore, the '625 patent discloses that the weight percent of the vegetables to be used is within the range of 12 to 20 weight percent, and in particular 16 weight percent. The '625 GB patent does not disclose an all-natural food product comprised solely of vegetables and yogurt, readily consumed. Rather, the disclosure of the '625 GB patent is directed to a food product containing a mixture of fruit and vegetables along with the use of preservatives in order to increase the shelf life of the food product. In addition, the '625 GB patent only discloses using vegetables ranging from 12 to 20 weight percent.

Japanese Patent No. JP 3112454 to Imaizumi et al. discloses a vegetable yogurt-jelly food product. The process for formulating the food product comprises the mixing of vegetables, yogurt, and a gelling agent. The '454 patent does not restrict the kinds of vegetable to be used, setting forth that any kind of leaf vegetable, root vegetable, fruit vegetable, stem vegetable, or flower vegetable can be used. The process sets forth that a conventional plain yogurt can be used as the yogurt. The gelling agent may be carrageenan, agar, gelatin, gellan gum, pectin, canthan gum or a mixture thereof. The purpose of the invention is to suppress the grassy smell of vegetables and improve the taste and flavor by mixing vegetables, yogurt and a gelling agent. Specifically, the '454 patent comprises a vegetable, gelling agent, and yogurt and is not a homogeneously mixed food product comprised purely of pureed vegetables and yogurt.

Japanese Patent No. JP 55007013 to Yotsuhashi discloses a process and food product. Gelatin, finely cut or ground vegetables, extracts, juices, or cooked vegetables are added to yogurt either before or after fermentation. The object of the process is to prepare a yogurt containing vegetables having softened fermentation odor and improved flavor, by adding vegetables to the yogurt during the preparation step. The vegetables are added to one or both layers of yogurt and a jelly is prepared by using a gelatinizing agent. Specifically, the food product in the '013 patent is prepared by fermenting vegetables either before or after their addition to the yogurt. Fermentation of the vegetables causes a chemical change in the vegetable by way of an enzymatic transformation of organic substrates. This chemical change decreases the overall nutritional properties of the vegetable.

Web-literature on Teri's Kitchen entitled “Tangy Yogurt Dip With Vegetable Crudités” at http://teriskitchen.com/appetize/yogurtdip-a.html discloses a vegetable dip recipe comprising the mixing of yogurt with various herbs. Fresh raw or cooked vegetables can then be immersed in the dip and consumed. The dip does not itself contain fresh raw or cooked vegetables, but is merely used for dipping such vegetables. The Dip reference discloses a recipe that calls for the brief immersion of a vegetable piece into the dip and is not a vegetable Yogurt Food Product containing a homogeneous mixture of the vegetable and yogurt.

Web-literature on Cook with Aloha entitled “Good Food/Good Health: Creative With Thanksgiving Day Tide-Me-Overs” at http://www.cookwithaloha.com/beandip.htm discloses vegetable chips comprising slicing vegetables (i.e. carrots, beets, or sweet potatoes) paper thin and baking them on an ungreased baking sheet until crisp, then dipping the vegetable chips into a dip. The site further discloses that blanched vegetables may be used as dippers for the dip as well, and discloses a recipe for a White Bean Dip. The dip disclosed by the Tide-Me-Over reference does not contain yogurt or pureed vegetables, but is merely to be used to coat the outer surface of vegetables by way of dipping the vegetable piece.

Web-literature on Chef2Chef entitled “Vegetables In Yogurt Sauce” at http://recipes.chef2chef.net/recipe-archive/52/276005.shtml discloses a recipe comprising the preparation of cooked vegetables, including zucchini, yellow squash, carrots, and green onions, basking in a sauce comprising various herbs. The recipe further calls for vegetable broth, sour cream, cornstarch and plain yogurt. The Sauce reference calls for cooking the vegetables in oil, and does not call for the cooking of vegetables by way of steam, boiling, or blanching of the vegetables. The recipe also discloses that herbs are to be added to the sauce until the desired taste is reached. The Sauce reference also discloses that equal parts yogurt and sour cream are to be used. This is a sauce and is clearly entirely distinct from a ready to eat vegetable yogurt product.

Web-literature on Sweet Baby Media entitled “Stamp For Fun: Curried Croquets” at http://www.sweetbabymedia.com/recipes/allbynumber4/017415.shtml by Jennifer Caher discloses a recipe for a sausage shaped appetizer comprised of cooked beans, chopped onion, curry, lemon and salt and pepper. The recipe sets forth that the appetizer may be served with salad, rice, vegetables, and soy yogurt mixed with fresh chopped mint and/or chopped chilies. Specifically, the reference does not disclose that the vegetables are to be homogeneously mixed with the soy yogurt. Instead, the reference indicates that the vegetables should act as a side to the yogurt. The recipe also discloses that herbs are to be added to the sauce until the desired taste is reached.

Web-literature on Dailyveg entitled “Nutrition in Childhood” at http://dailyveg.com/other/childhood.php by Reed Mangels and Katie Kavanagh-Prochaska discusses the food diets of vegan children, setting forth various nutrients needed and sources in which they can be found. The article suggests some special tips for feeding preschoolers by cutting vegetables into different shapes and hiding small pieces of soft fruit in soy yogurt. It also suggests chopping or pureeing vegetables and adding them to pasta sauce or soup.

The article concludes with sample meal plans for vegan children from infancy to childhood.

Significantly, the reference does not disclose a vegetable yogurt derived from soy or from milk protein. In addition, there is no disclosure in the reference concerning a process for producing a vegetable yogurt food product. The reference merely discusses vegetables in the sense of chopping vegetables into various shapes or pureeing vegetables and adding them to sauces or soups. It does not discuss a vegetable yogurt product with a homogenous texture.

There remains a need in the art for a ready to eat vegetable yogurt food product that has a creamy smooth texture, is all-natural, and derived from a homogenous mixture of yogurt and adequate quantities of freshly cooked pureed vegetables, providing nutritional and essential vitamins, minerals, and fiber to the consumer's diet.

### SUMMARY OF THE INVENTION

The present invention provides a ready to eat cooked and pureed vegetable yogurt food product and a process for the production thereof. The ready to eat vegetable yogurt food product is an all-natural product comprised of cooked cooled and pureed vegetables and milk protein or soy based yogurt with active cultures such as Lactobacillus acidophilus, Lactobacillus casei, Lactobacillus reuteri and Bifidobacterium bifidum. The ready to eat vegetable yogurt also contains taste and flavor enhancing additions such as salt, sugar, herbs etc. There are no artificial additives or preservatives in the ready to eat vegetable yogurt, both of which affect the taste and nutritional properties of food products.

Fresh, frozen or canned vegetables may be used in making the vegetable yogurt food product. The vegetables are cooked according to the vegetable type and cooled immediately to prevent overcooking and to preserve freshness and taste. One or more of the cooked vegetables are mixed and pureed to form a smooth mixture. Typical vegetables used may include carrots, peas, corn, green beans, cauliflower, broccoli, potatoes, zucchini, tomatoes, yams, squash, beets, or/and other vegetables equally well suitable for use in the ready to eat vegetable yogurt. This smooth mixture is blended with the yogurt with active cultures so as to form a homogenous uniform mixture of ready to eat vegetable yogurt.

The ready to eat vegetable yogurt is stored and maintained at refrigerator temperatures until it is consumed in order to preserve the freshness, taste, and nutritional properties of the cooked vegetables by preventing the fermentation of the cooked vegetables, which results at warm temperatures due to the active cultures found in the yogurt. This homogenous uniform ready to eat vegetable yogurt can be consumed by young children as well as elderly person without the hazards of choking.

Advantageously, since complete vegetables are used, all the nutritional essential vitamins, minerals, and fibers inherent in the vegetable are preserved in the ready to eat vegetable yogurt. Typically the cooked vegetable content in the ready to eat vegetables ranges from 30 to 70% by weight, preferably from 40 to 60% by weight, more preferably from 48 to 53% by weight. The yogurt with active cultures may be based on milk proteins or soy proteins. Sugar or other sweeteners may be added to improve taste.

The process utilized in making the ready to eat vegetable yogurt comprises: (i) cooking the vegetables, including the use of fresh, frozen, or canned vegetables; (ii) cooling the vegetables to prevent over cooking; (iii) pureeing the cooked vegetables into a smooth, uniform consistency; (iv) determining the specific weight percent of the vegetable to add to the cold plain yogurt; and (v) slowly combining the cooled pureed cooked vegetables to the cold plain yogurt to form a homogeneous, smooth, mixture. The homogenous smooth ready to eat vegetable yogurt is stored at refrigeration temperatures to prevent fermentation of the vegetable product mixed in the yogurt so that the taste, flavor, and nutritional integrity of the cooked vegetable is preserved.

The plain yogurt used is preferably a soy yogurt, however yogurts made from milk protein may be used. Other flavor enhancers, such as sugar (or other sweeteners), herbs, and salt, may be added to the ready to eat vegetable yogurt to improve the taste, while retaining the nutritional values of the food product. The vegetable content can range from 30 to 70 weight percent, preferably from 40 to 60 weight percent, and most preferably from 48 to 53 weight percent, depending on the vegetable or vegetable mixture used.

The process for the manufacture of ready to eat vegetable yogurt comprises the steps of cooking selected vegetables one at a time or combining them together especially if they have similar cooking times. The cooked vegetables should be cooled in order to prevent overcooking and preserve the freshness and taste of the cooked vegetable. Several cooked and cooled vegetables are mixed together and pureed to form a smooth textured mixture. Flavor and taste enhancing natural additives may be added to the mixture. This cooked cooled pureed vegetable mixture is then added to cold yogurt, further containing active cultures of Lactobacillus acidophilus, Lactobacillus casei, Lactobacillus reuteri and Bifidobacterium bifidum. The mixture is then blended to form a homogenous, uniform, smooth mixture of ready to eat vegetable yogurt.

The ready to eat vegetable yogurt is stored and maintained at refrigeration temperatures until consumed so as to preserve the freshness and taste of the cooked cooled pureed vegetable yogurt food product and to prevent fermentation of the cooked cooled pureed vegetables by the active cultures contained in the yogurt. The yogurt used may be a soy based yogurt or a milk based yogurt. The cooked cooled pureed vegetable content in the ready to eat vegetable yogurt ranges from 30 to 70%, preferably 40 to 60%, more preferably 48 to 53%.

### DESCRIPTION OF THE PREFERRED EMBODIMENTS

The present invention relates to a ready to eat cooked and pureed vegetable yogurt food product and a process for the production thereof. The ready to eat vegetable yogurt food product is an all-natural product comprised of cooked pureed vegetables and yogurt. Since complete vegetables are used, all the natural nutritional values of the vegetable, including vitamins, minerals and fibers, are preserved in the ready to eat vegetable yogurt. Furthermore, the ready to eat vegetable yogurt does not call for the addition of any artificial additives or preservatives, both of which affect the taste and the nutritional properties of food products.

Particularly, the process utilized in making the ready to eat vegetable yogurt comprises: (i) cooking the vegetables, including the use of fresh, frozen, or canned vegetables; (ii) cooling the vegetables to prevent over cooking; (iii) pureeing the cooked cooled vegetables into a smooth, uniform consistency; (iv) determining the specific weight percent of the vegetable to add to the cold plain yogurt; and (v) slowly combining the cooled pureed cooked vegetables to the cold plain yogurt to form a homogeneous, smooth, mixture. The homogenous smooth ready to eat vegetable yogurt is stored at refrigerated temperatures to prevent fermentation of and preserve flavor, taste, and nutritional integrity of the cooked pureed vegetable product mixed in the yogurt. The plain yogurt used is preferably a soy yogurt, however yogurts made from milk protein may be used. Flavor enhances such as sugar (or other sweeteners), salt, or herbs may be advantageously added to the ready to eat vegetable yogurt. The vegetable content can range from 30 to 70 percent by weight, preferably from 40 to 60 weight percent and most preferably 48 to 53 weight percent, depending on the vegetable or vegetable mixture used.

Vegetables are regarded as a highly desirable food due to their nutritional value as the number one source for certain dietary vitamins. Health experts have determined that proper levels of nutrients provided by vegetables aid in the prevention of various diseases. Despite these advantageous health benefits, many adults and children do not consume beneficial quantities of vegetables on a daily basis in their diets. This deficiency is due to many reasons, such as the lack of time required for preparation of vegetable entries, the taste of the vegetables, and the consistency of certain vegetables. In particular, elderly or young children may not be able to ingest high fibrous consistency of vegetables due to choking hazards and lack of chewing ability.

Advantageously, the process for producing ready to eat vegetable yogurt utilizes a minimum of kitchen utensils, and results in an appetizing, nutritious entry that is readily prepared. Each vegetable has a slightly different cooking time and the process may cook the vegetables separately. For example carrots, peas and broccoli require very little cooking time. Vegetables like tomatoes potatoes, yams, zucchini and squash require moderate cooking time. Vegetables like beets root require prolonged cooking time. The cooking process may involve boiling, steaming, microwave cooking, quartz halogen lamp radiation cooking, stir-frying and other methods of cooking. The cooked vegetable is rapidly cooled to prevent overcooking which will damage the flavor, taste and nutritional value of the vegetable.

The cooled vegetables are mixed and pureed to form a smooth cold mixture. This pureed cold vegetable mixture is added to cold plain yogurt and blended to form a smooth ready to eat vegetable yogurt and is stored at refrigeration temperatures until consumed. Additional natural flavor enhancers may be added to adjust the taste without compromising the healthful value of the vegetable yogurt food product. The cold plain yogurt typically comprises active cultures of Lactobacillus acidophilus, Lactobacillus casei, Lactobacillus reuteri and Bifidobacterium bifidum. Natural taste and flavor enhancers such as fresh herbs, salt, and/or sugar (or other sweeteners) may also be added.

Keeping the ready to eat vegetable yogurt at the refrigeration temperature prevents the active yogurt culture from fermenting the vegetable products, added sugar and added flavor enhancers. Advantageously, with ready to eat vegetable yogurt, there is retained a natural, unfermented, chemical make up of the vegetables, which are combined with the yogurt in a pureed condition to produce a highly nutritious, delicious, and readily made food product.

The key features of the process for ready to eat cooked and pureed vegetable yogurt includes, in combination, the following features: (i) the process for preparing ready to eat vegetable yogurt comprises the steps of cooking each vegetable separately according to vegetable type; (ii) cooling each vegetable to prevent over cooking; (iii) mixing the cooked cooled vegetables; (iv) pureeing the cooked cooled vegetables to a smooth consistency; (v) adding the cold vegetable mix to cold plain yogurt with active cultures comprising Lactobacillus acidophilus, Lactobacillus casei, Lactobacillus. reuteri and Bifidobacterium bifidum; (vi) adding natural additives including salt, sugar (or other sweeteners), and other taste and flavor enhancers; (vii) blending yogurt with vegetables to form a homogeneous, uniform mixture of ready to eat vegetable yogurt; and (viii) storing ready to eat vegetable yogurt at refrigeration temperatures until consumed. Furthermore, wherein (i) the plain yogurt used is derived from a milk protein base or from soy protein base; (ii) the vegetable used is selected from one of or combinations of a fresh vegetable, a canned vegetable or a frozen vegetable; and (iii) the vegetable content ranges from 30 to 70 percent by weight, preferably ranges from 40 to 60 percent by weight, most preferably ranges from 48 to 53 percent by weight.

Having thus described the invention in rather full detail, it will be understood that such detail need not be strictly adhered to, but that additional changes and modifications may suggest themselves to one skilled in the art, all falling within the scope of the invention as defined by the subjoined claims.

1. A ready to eat vegetable yogurt, comprising:
a. cooked pureed vegetables;
b. plain yogurt comprising active cultures of Lactobacillus acidophilus, Lactobacillus casei, Lactobacillus reuteri and Bifidobacterium bifidum;
c. natural additives to enhance flavor and taste;
d. said cooked pureed vegetables, said plain yogurt with active cultures and said additives blended to form a homogeneous, uniform mixture of ready to eat vegetable yogurt;
e. said ready to eat vegetable yogurt stored at refrigeration temperatures until consumed;
whereby said cooked pureed vegetables remain unfermented when the vegetable yogurt is stored at refrigeration temperature.

2. A ready to eat vegetable yogurt as recited by claim 1 wherein said cooked pureed vegetables are formed by individually cooking, cooling and mixing of several vegetables and pureeing together to form a smooth mixture.

3. A ready to eat vegetable yogurt as recited by claim 1 wherein said cooked pureed vegetables comprise one or more of carrots, peas, beets, corn, cauliflower, broccoli, potatoes, green beans, zucchini, tomatoes, yams and squash.

4. A ready to eat vegetable yogurt as recited by claim 1 wherein said yogurt is based on soy proteins.

5. A ready to eat vegetable yogurt as recited by claim 1 wherein said yogurt is based on milk proteins.

6. A ready to eat vegetable yogurt as recited by claim 1 wherein said additive for enhancing flavor is a fresh herb;

7. A ready to eat vegetable yogurt as recited by claim 1 wherein said additive for enhancing taste is sugar (or other sweeteners).

8. A ready to eat vegetable yogurt as recited by claim 1 wherein said cooked pureed vegetables range from 30 to 70 percent by weight.

9. A ready to eat vegetable yogurt as recited by claim 1 wherein said cooked pureed vegetables range from 40 to 60 percent by weight.

10. A ready to eat vegetable yogurt as recited by claim 1 wherein said cooked pureed vegetables range from 48 to 53 percent by weight.

11. A process for manufacturing ready to eat vegetable yogurt comprising steps of
a. cooking selected vegetables one at a time or together depending one the vegetable type;
b. cooling the said cooked vegetables so as to prevent overcooking and preserve freshness and taste;
c. mixing said cooked cooled vegetables to form a mixture;
d. pureeing said mixture to form a smooth textured mixture;
e. adding said smooth mixture of cooked cooled pureed vegetables to yogurt with active cultures to form a cold yogurt mixture;
f. adding natural additives that enhance taste and flavor;
g. blending the said cold yogurt mixture to produce a homogenous uniform mixture of ready to eat vegetable yogurt;
h. maintaining said ready to eat vegetable yogurt at refrigeration temperature until consumed so as to preserve the freshness and taste of cooked cooled pureed vegetables and to prevent fermentation thereof by the active cultures of said yogurt.

12. A process for manufacturing ready to eat vegetable yogurt as recited in claim 11 wherein said yogurt is soy based.

13. A process for manufacturing ready to eat vegetable yogurt as recited in claim 11 wherein said yogurt is milk based.

14. A process for manufacturing ready to eat vegetable yogurt as recited in claim 11 wherein said vegetable used is selected from one of or combinations of a fresh vegetable, a canned vegetable or a frozen vegetable.

15. A process for manufacturing ready to eat vegetable yogurt as recited in claim 11 wherein said cooked pureed vegetables comprise one or more of carrots, peas, green beans, corn, beets, cauliflower, broccoli, potatoes, zucchini, tomatoes, yams and squash.

16. A process for manufacturing ready to eat vegetable yogurt as recited in claim 11 wherein said cooked pureed vegetables range from 30 to 70 percent by weight.

17. A process for manufacturing ready to eat vegetable yogurt as recited in claim 11 wherein said cooked pureed vegetables range from 40 to 60 percent by weight.

18. A process for manufacturing ready to eat vegetable yogurt as recited in claim 11 wherein said cooked pureed vegetables range from 48 to 53 percent by weight.
